(19) United States
(12) Patent Application Publication
(10) Pub. No.: US 2019/0102948 A1
(43) Pub. Date: Apr. 4, 2019

(54) IMAGE DISPLAY DEVICE, IMAGE DISPLAY METHOD, AND COMPUTER READABLE MEDIUM

(71) Applicant: MITSUBISHI ELECTRIC CORPORATION, Tokyo (JP)

(72) Inventors: Yoshihiro TOMARU, Tokyo (JP); Takefumi HASEGAWA, Tokyo (JP)

(73) Assignee: MITSUBISHI ELECTRIC CORPORATION, Tokyo (JP)

(21) Appl. No.: 16/088,514

(22) PCT Filed: May 17, 2016
(86) PCT No.: PCT/JP2016/064648

§ 371 Date: Sep. 26, 2018

(51) Int. Cl. G06T 19/00

(52) U.S. Cl. CPC G06T 19/006; G06T 2210/21

(57) ABSTRACT

An image display device acquires information of an object around a moving body and determines whether shielding is allowed or not allowed for the object according to whether an acquired importance of the object is higher than a threshold value. The image display device displays image data indicating the object by superimposing it on a scenery around the moving body regardless of a position of the object, with respect to the object for which it is determined that the shielding is not allowed, and determines whether to display the object by superimposing it on the scenery in accordance with the position of the object, with respect to the object for which it is determined that the shielding is allowed.

### TECHNICAL FIELD

The present invention relates to a technique for displaying an object around a moving body by superimposing the object on a scenery around the moving body.

### BACKGROUND ART

There is a technique of superimposing and displaying navigation data as a CG (Computer Graphics) content on the scenery which is an image in front of a vehicle captured by a camera as if it were in the scenery. Patent Literatures 1 and 2 describe this technique.

In Patent Literature 1, two depths of the scenery and the CG content to be superimposed are compared. In Patent Literature 1, when it is determined that the CG content is located at the far side of the scenery, the content of the corresponding portion is not displayed, and when it is determined that the CG content is on the near side of the scenery, the content of the corresponding portion is displayed. This makes a shielding relationship between the scenery and the content consistent with the reality and enhances a sense of reality.

In Patent Literature 2, peripheral objects such as a forward vehicle obtained by an in-vehicle sensor are also displayed in the same manner as in Patent Literature 1.

### CITATION LIST

### Patent Literature

Patent Literature 1: WO-2013-111302

Patent Literature 2: JP-A-2012-208111

### SUMMARY OF INVENTION

### Technical Problem

In Patent Literatures 1 and 2, the CG content is displayed in accordance with a real positional relationship. Therefore, it has been sometimes difficult to see the CG content displaying information such as a destination mark and a gas station mark which a driver wants to see, and information such as an obstacle on a road and a forward vehicle which the driver should see. As a result, the driver may have overlooked these information.

An object of the present invention is to make it easy to see necessary information while maintaining a sense of reality.

### Solution to Problem

An image display device according to the present invention includes:
an object information acquisition unit to acquire information of an object around a moving body;
a shielding determination unit to determine that shielding is not allowed for the object when an importance of the object acquired by the object information acquisition unit is higher than a threshold value; and
a display control unit to display image data indicating the object by superimposing it on a scenery around the moving body regardless of a position of the object, with respect to the object for which it is determined by the shielding determination unit that the shielding is not allowed.

### Advantageous Effects of Invention

According to the present invention, it is possible to make it easy to see the necessary information while maintaining the sense of reality by switching presence or absence of the shielding according to an importance of the object.

### BRIEF DESCRIPTION OF DRAWINGS

FIG. 1 is a configuration diagram of an image display device 10 according to Embodiment 1.

FIG. 2 is a flowchart illustrating an overall process of the image display device 10 according to Embodiment 1.

FIG. 3 is a diagram illustrating a circumstance around a moving body 100 according to Embodiment 1.

FIG. 4 is a diagram illustrating an image in front of the moving body 100 according to Embodiment 1.

FIG. 5 is a diagram illustrating a depth map according to Embodiment 1.

FIG. 6 is a flowchart illustrating a normalization process in Step S3 according to Embodiment 1.

FIG. 7 is a diagram illustrating an object around the moving body 100 according to Embodiment 1.

FIG. 8 is a flowchart illustrating a navigation data acquisition process in Step S4 according to Embodiment 1.

FIG. 9 is a flowchart illustrating a model generation process in Step S6 according to Embodiment 1.

FIG. 10 is an explanatory diagram of a 3D model corresponding to peripheral data according to Embodiment 1.

FIG. 11 is an explanatory diagram of a 3D model corresponding to navigation data 41 according to Embodiment 1.

FIG. 12 is a diagram illustrating a 3D model corresponding to the object around the moving body 100 according to Embodiment 1.

FIG. 13 is a flowchart illustrating a shielding determination process in Step S8 according to Embodiment 1.

FIG. 14 is a flowchart illustrating a model drawing process in Step S9 according to Embodiment 1.

FIG. 15 is a diagram illustrating an image at an end of Step S95 according to Embodiment 1.

FIG. 16 is a diagram illustrating an image at an end of Step S98 according to Embodiment 1.

FIG. 17 is a configuration diagram of an image display device 10 according to Modification 1.

FIG. 18 is a flowchart illustrating a shielding determination process in Step S8 according to Embodiment 2.

FIG. 19 is a diagram illustrating an image at an end of Step S95 according to Embodiment 2.

FIG. 20 is a diagram illustrating an image at an end of Step S98 according to Embodiment 2.

FIG. 21 is an explanatory diagram when a destination is close according to Embodiment 2.

FIG. 22 is a diagram illustrating an image at the time of Step S98 when the destination is close according to Embodiment 2.

FIG. 23 is a configuration diagram of an image display device 10 according to Embodiment 3.

FIG. 24 is a flowchart illustrating the overall process of the image display device 10 according to Embodiment 3.

FIG. 25 is a flowchart illustrating a shielding determination process in Step S8C according to Embodiment 3.

FIG. 26 is a diagram illustrating an image at an end of Step S95 according to Embodiment 3.

FIG. 27 is a diagram illustrating an image at an end of Step S98 according to Embodiment 3.

### DESCRIPTION OF EMBODIMENTS

### Embodiment 1

***Description of Configuration***

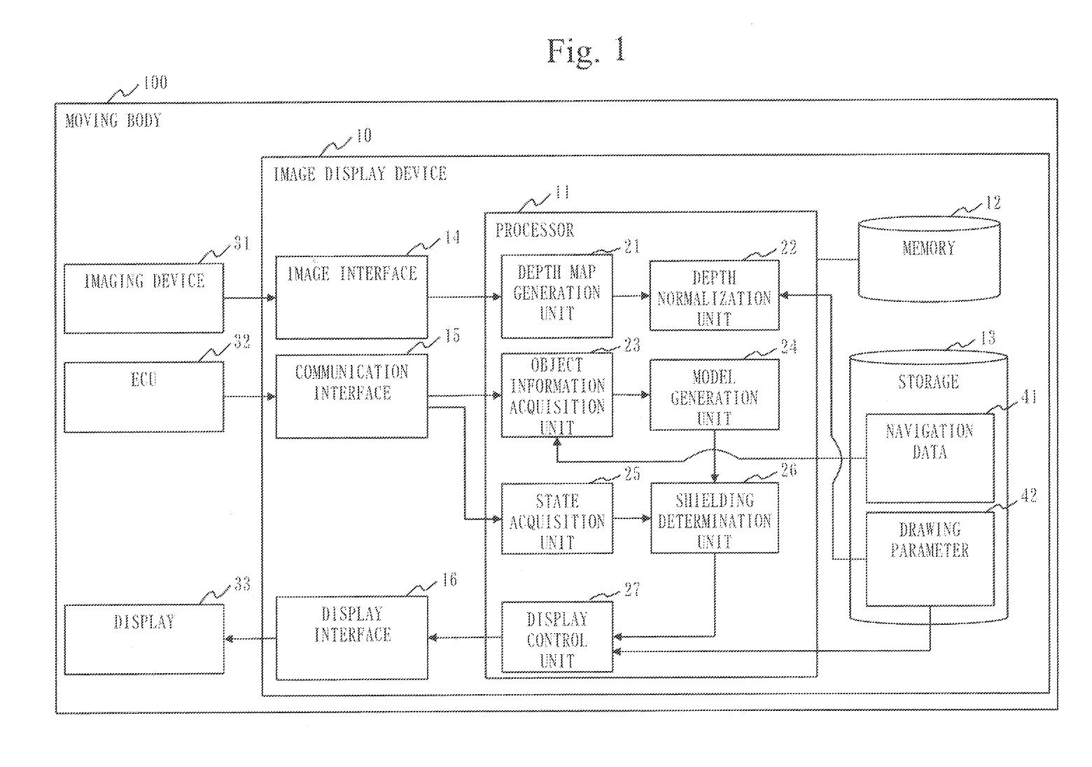

A configuration of an image display device 10 according to Embodiment 1 will be described with reference to FIG. 1.

FIG. 1 illustrates a state in which the image display device 10 is mounted on a moving body 100. As a specific example, the moving body 100 is a vehicle, a ship or a pedestrian. In Embodiment 1, the moving body 100 is the vehicle.

The image display device 10 is a computer mounted on the moving body 100.

The image display device 10 includes hardware of a processor 11, a memory 12, a storage 13, an image interface 14, a communication interface 15, and a display interface 16. The processor 11 is connected to other hardware via a system bus and controls these other hardware.

The processor 11 is an integrated circuit (IC) which performs processing. As a specific example, the processor 11 is a central processing unit (CPU), a digital signal processor (DSP), or a graphics processing unit (GPU).

The memory 12 is a work area in which data, information, and programs are temporarily stored by the processor 11. The memory 12 is a random access memory (RAM) as a specific example.

As a specific example, the storage 13 is a read only memory (ROM), a flash memory, or a hard disk drive (HDD). Further, the storage 13 may be a portable storage medium such as a Secure Digital (SD) memory card, a CompactFlash (CF), a NAND flash, a flexible disk, an optical disk, a compact disk, a Blu-ray (registered trademark) disk, or a DVD.

The image interface 14 is a device for connecting an imaging device 31 mounted on the moving body 100. As a specific example, the image interface 14 is a terminal of Universal Serial Bus (USB), or High-Definition Multimedia Interface (HDMI, registered trademark).

A plurality of imaging devices 31 for capturing an image around the moving body 100 are mounted on the moving body 100. In Embodiment 1, two imaging devices 31 for capturing the image in front of the moving body 100 are mounted at a distance of several tens of centimeters in front of the moving body 100. The imaging device 31 is a digital camera as a specific example.

The communication interface 15 is a device for connecting an Electronic Control Unit (ECU) 32 mounted on the moving body 100. As a specific example, the communication interface 15 is a terminal of Ethernet, Controller Area Network (CAN), RS232C, USB, or IEEE1394.

The ECU 32 is a device which acquires information of an object around the moving body 100 detected by a sensor such as a laser sensor, a millimeter wave radar, or a sonar mounted on the moving body 100. Further, the ECU 32 is a device which acquires information detected by a sensor such as a Global Positioning System (GPS) sensor, a direction sensor, a speed sensor, an acceleration sensor, or a geomagnetic sensor mounted on the moving body 100.

The display interface 16 is a device for connecting a display 33 mounted on the moving body 100. As a specific example, the display interface 16 is a terminal of Digital Visual Interface (DVI), D-SUBminiature (D-SUB), or HDMI (registered trademark).

The display 33 is a device for superimposing and displaying a CG content on a scenery around the moving body 100. As a specific example, the display 33 is a liquid crystal display (LCD), or a head-up display.

The scenery here is either an image captured by the camera, a three-dimensional map created by computer graphics, or a real object which can be seen through a head-up display or the like. In Embodiment 1, the scenery is the image in front of the moving body 100 captured by the imaging device 31.

The image display device 10 includes, as functional components, a depth map generation unit 21, a depth normalization unit 22, an object information acquisition unit 23, a model generation unit 24, a state acquisition unit 25, a shielding determination unit 26, and a display control unit 27. Functions of the depth map generation unit 21, the depth normalization unit 22, the object information acquisition unit 23, the model generation unit 24, the state acquisition unit 25, the shielding determination unit 26, and the display control unit 27 are realized by software.

Programs for realizing the functions of the respective units are stored in the storage 13. This program is read into the memory 12 by the processor 11 and executed by the processor 11.

Further, navigation data 41 and drawing parameter 42 are stored in the storage 13. The navigation data 41 is data for guiding an object to be navigated such as a gas station and a pharmacy. The drawing parameter 42 is data indicating a nearest surface distance which is a near side limit distance and a farthest surface distance which is a far side limit distance in a drawing range in graphics, a horizontal viewing angle of the imaging device 31, and an aspect ratio (horizontal/vertical) of the image captured by the imaging device 31.

Information, data, signal value, variable value indicating the processing result of the function of each unit of the image display device 10 are stored in the memory 12 or a register or a cache memory in the processor 11. In the following description, it is assumed that the information, the data, the signal value, and the variable value indicating the processing result of the function of each unit of the image display device 10 are stored in the memory 12.

In FIG. 1, only one processor 11 is illustrated. However, the number of the processors 11 may be plural, and a plurality of processors 11 may execute the programs realizing the respective functions in cooperation.

***Description of Operation***

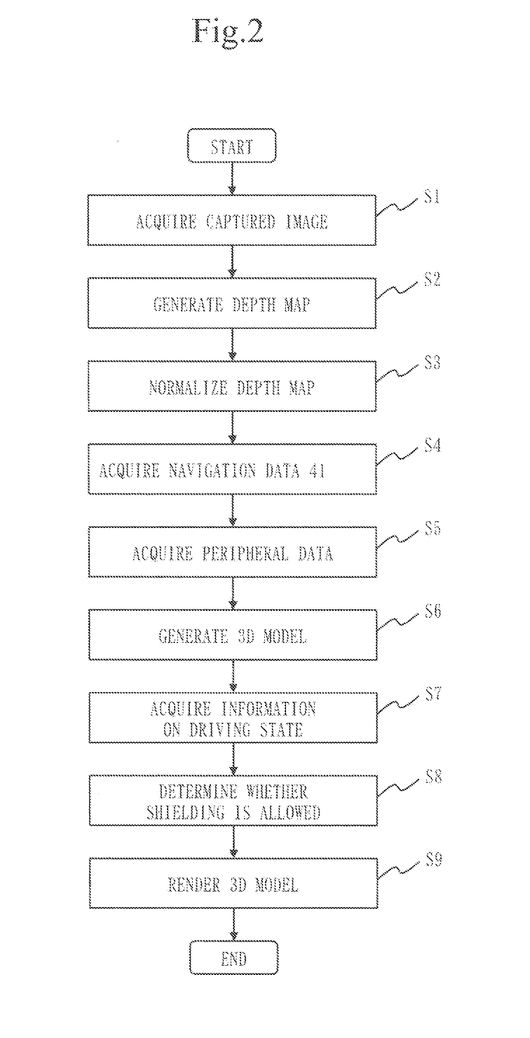

An operation of the image display device 10 according to Embodiment 1 will be described with reference to FIGS. 2 to 14.

The operation of the image display device 10 according to Embodiment 1 corresponds to an image display method according to Embodiment 1. Further, the operation of the image display device 10 according to Embodiment 1 corresponds to the process of the image display program according to Embodiment 1.

(Step S1 in FIG. 2: Image Acquisition Process)

The depth map generation unit 21 acquires the image in front of the moving body 100 captured by the imaging device 31 via the image interface 14. The depth map generation unit 21 writes the acquired image into the memory 12.

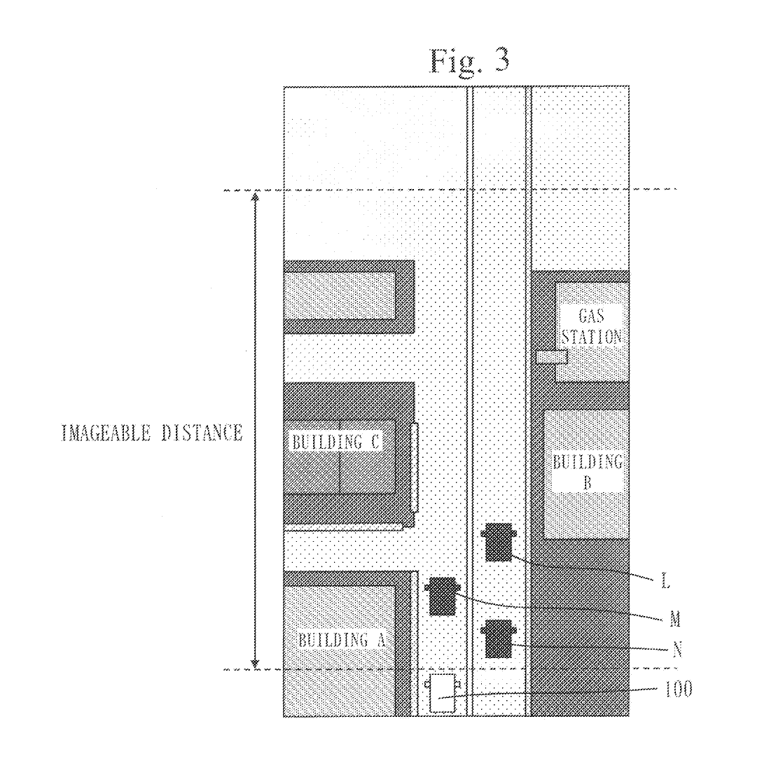

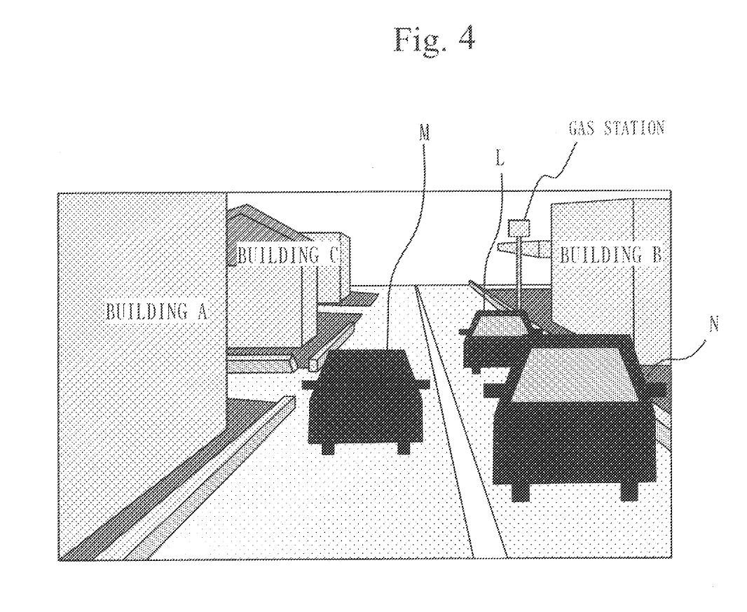

In Embodiment 1, as the imaging device 31, two digital cameras are mounted at an interval of several tens of centimeters in front of the moving body 100. As illustrated in FIG. 3, it is assumed that there are surrounding vehicles L, M, and N in front of the moving body 100, and there is a plurality of buildings on the side of the road. Then, as illustrated in FIG. 4, the image capturing the front of the moving body 100 by a stereo camera is obtained. Here, as illustrated in FIG. 3, an imageable distance indicating a range captured by the imaging device 31 is the maximum capturable distance in an optical axis direction of the imaging device 31.

(Step S2 in FIG. 2: Map Generation Process)

The depth map generation unit 21 generates a depth map indicating a distance from the imaging device 31 to a subject for each pixel of the image acquired in Step S1. The depth map generation unit 21 writes the generated depth map into the memory 12.

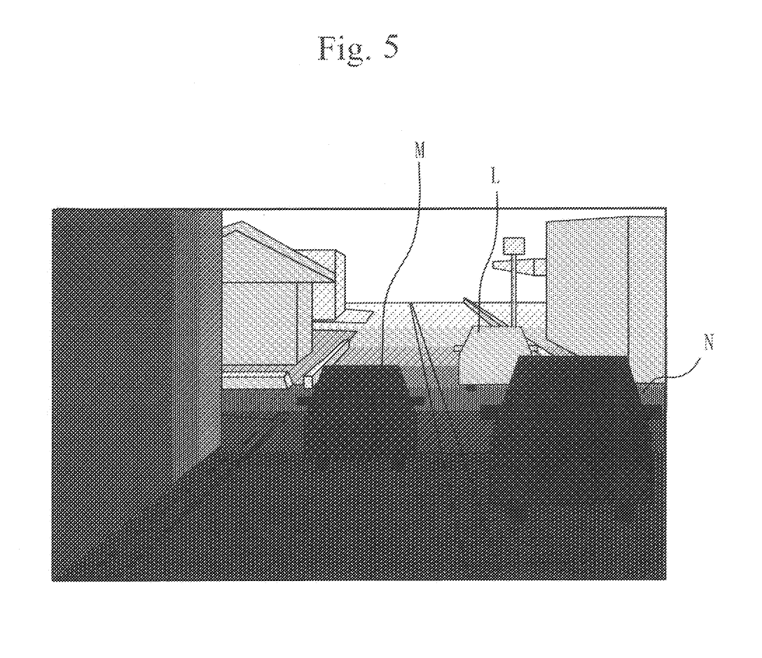

In Embodiment 1, the depth map generation unit 21 generates the depth map by a stereo method. Specifically, the depth map generation unit 21 finds a pixel capturing the same object in images captured by the two cameras, and determines a distance of the pixel found by triangulation. The depth map generation unit 21 generates a depth map by calculating distances for all the pixels. The depth map generated from the image illustrated in FIG. 4 is as illustrated in FIG. 5, and each pixel indicates the distance from the camera to the subject. In FIG. 5, a value is smaller as it is closer to the camera, and is larger as it is farther from the camera, so that the closer side is shown by denser hatching, and the farther side is shown by thinner hatching.

(Step S3 in FIG. 2: Normalization Process)

The depth normalization unit 22 converts the calculated distance in the real world, which is the distance in the depth map generated in Step S2, into a distance for drawing with 3D (Dimensional) graphics using the drawing parameter 42 stored in the storage 13. Thus, the depth normalization unit 22 generates a normalized depth map. The depth normalization unit 22 writes the normalized depth map into the memory 12.

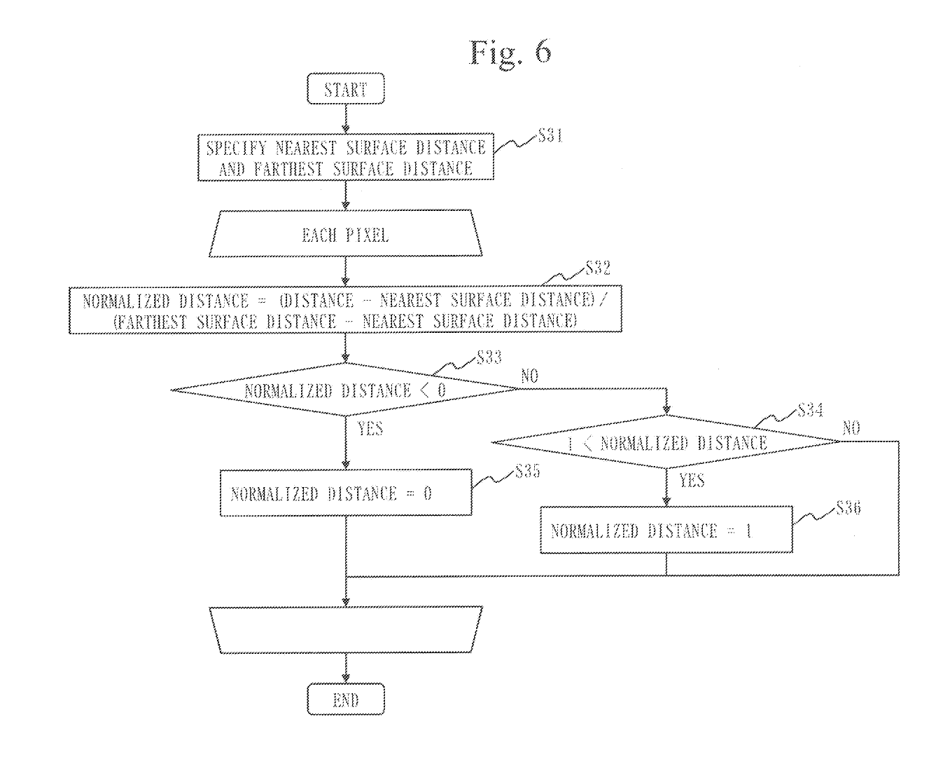

It will be specifically described with reference to FIG. 6.

First, in Step S31, the depth normalization unit 22 acquires the drawing parameter 42 and specifies the nearest surface distance and the farthest surface distance. Next, the depth normalization unit 22 performs processes from Step S32 to Step S36 with each pixel of the depth map generated in Step S2 as a target pixel.

In Step S32, the depth normalization unit 22 divides a value obtained by subtracting the nearest surface distance from the distance of the target pixel by a value obtained by subtracting the nearest surface distance from the farthest surface distance to calculate the normalized distance of the target pixel. In Step S33 to Step S36, the depth normalization unit 22 sets the distance of the target pixel to 0 when the normalized distance calculated in Step S32 is smaller than 0, sets the distance of the target pixel to 1 when the normalized distance calculated in Step S32 is larger than 1, and sets the distance of the target pixel to the distance calculated in Step S32 in other cases.

Thus, the depth normalization unit 22 expresses the distance of the target pixel as a dividing ratio with respect to the nearest surface distance and the farthest surface distance, and converts it into a value linearly interpolated in a range of 0 to 1.

(Step S4 in FIG. 2: Navigation Data Acquisition Process)

The object information acquisition unit 23 reads and acquires the navigation data 41 stored in the storage 13, which is information on the object existing around the moving body 100. The object information acquisition unit 23 converts a position of the acquired navigation data 41 from a geographic coordinate system which is an absolute coordinate system to a relative coordinate system having the imaging device 31 as a reference. Then, the object information acquisition unit 23 writes the acquired navigation data 41 into the memory 12 together with the converted position.

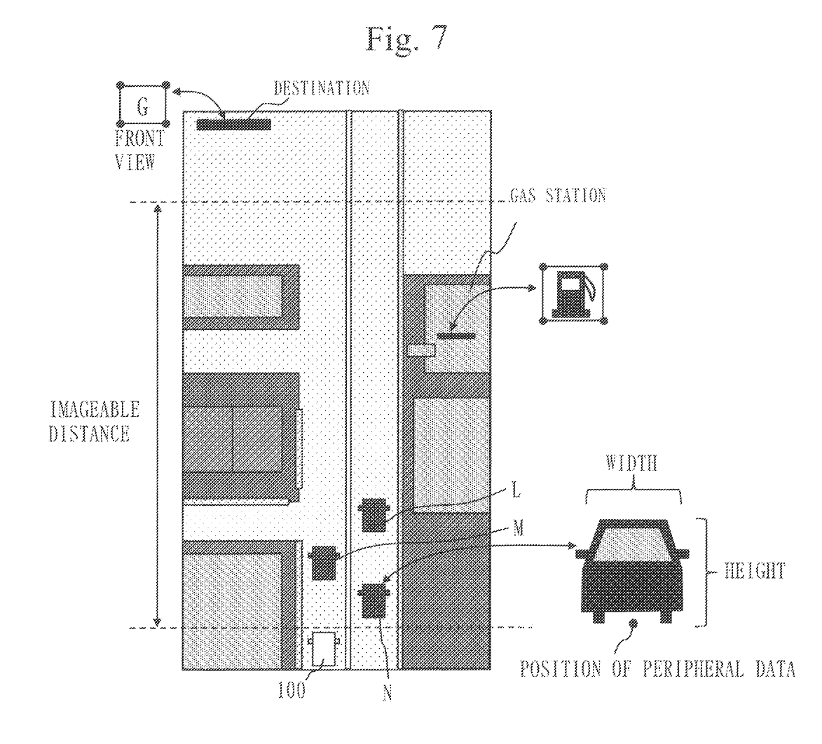

In the case of FIG. 3, for example as illustrated in FIG. 7, the navigation data 41 on a destination and the gas station is acquired. In FIG. 7, the gas station is at a position within the imageable distance of the imaging device 31, and the destination is at a position being the imageable distance or more away from the imaging device 31.

As illustrated in FIG. 7, the navigation data 41 includes positions of four end points of a display area of a 3D model for the object represented by the geographic coordinate system. The geographic coordinate system is a coordinate system in which an X-axis is in the longitudinal direction, a Z-axis is in the latitude direction, a Y-axis is in an elevation direction in the Mercator projection, the origin is the Greenwich Observatory, and the unit is the metric system. On the other hand, the relative coordinate system is a coordinate system in which the X-axis is in a right direction of the imaging device 31, the Z-axis is in the optical axis direction, the Y-axis is in an upward direction, the origin is the position of the imaging device 31, and the unit is the metric system.

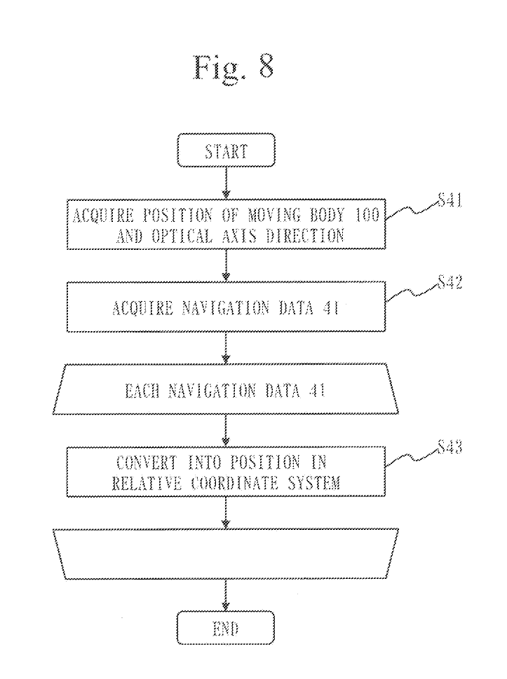

It will be specifically described with reference to FIG. 8.

In Step S41, the object information acquisition unit 23 acquires the position in the geographic coordinate system of the imaging device 31 and the optical axis direction in the geographic coordinate system of the imaging device 31 from the ECU 32 via the communication interface 15.

The position and the optical axis direction of the imaging device 31 in the geographic coordinate system can be specified by a dead reckoning method using a sensor such as a GPS sensor, a direction sensor, an acceleration sensor, or a geomagnetic sensor. Thus, the position of the imaging device 31 in the geographic coordinate system can be acquired as an X value (CarX), a Y value (CarY), and a Z value (CarZ) of the geographic coordinate system. Further, the optical axis direction in the geographic coordinate system of the imaging device 31 can be acquired as a 3×3 rotation matrix for converting from the geographic coordinate system to the relative coordinate system.

In Step S42, the object information acquisition unit 23 acquires the navigation data 41 of the object existing around the moving body 100. Specifically, the object information acquisition unit 23 collects the navigation data 41 of the object existing within a radius of several hundred meters of the position acquired in Step S41. More specifically, it is sufficient to collect only the navigation data 41 in which an existing position and an acquisition radius of the navigation data 41 in the geographic coordinate system satisfy a relationship of “(NaviX−CarX)²+(NaviZ−CarZ)²≤R²”. Here, NaviX and NaviZ are the X value and the Z value of the position of the navigation data in the geographic coordinate system, and R is the acquisition radius. The acquisition radius R is arbitrarily set.

The object information acquisition unit 23 performs Step S43 with each navigation data 41 acquired in Step S42 as target data. In Step S43, the object information acquisition unit 23 converts the position of the navigation data 41 in the geographic coordinate system into the position in the relative coordinate system by calculating Equation 1.

$$( \begin{matrix}NaviX\_rel \\ NaviY\_rel \\ NaviZ\_rel\end{matrix} ) = {Mat}_{CarR} ( \begin{matrix}NaviX - CarX \\ NaviY - CarY \\ NaviZ - CarZ\end{matrix} ) \qquad [ Equation 1 ]$$

Here, NaviY is the Y value of the position in the geographic coordinate system of the navigation data 41. Mat_{CarR} is a rotation matrix indicating the optical axis direction in the geographic coordinate system of the imaging device 31 obtained in Step S41. NaviX_rel, NaviY_rel and NaviZ_rel are the X value, the Y value and the Z value of the position in the relative coordinate system of the navigation data 41.

(Step S5 in FIG. 2: Peripheral Data Acquisition Process)

The object information acquisition unit 23 acquires peripheral data which is information on the object existing around the moving body 100 from the ECU 32 via the communication interface 15. The object information acquisition unit 23 writes the acquired peripheral data into the memory 12.

The peripheral data is sensor data obtained by recognizing the object using a sensor value detected by the sensor such as the laser sensor, the millimeter wave radar, or the sonar. The peripheral data indicates a size including a height and a width, the position in the relative coordinate system, a moving speed, and a type such as a car, a person, or a building of the object.

In the case of FIG. 3, as illustrated in FIG. 7, the peripheral data on the objects of the surrounding vehicles M to L is acquired. As illustrated in FIG. 7, the position indicated by the peripheral data is a center position of a lower side in a surface on the moving body 100 side of the object.

(Step S6 in FIG. 2: Model Generation Process)

The model generation unit 24 reads the navigation data 41 acquired in Step S4 and the peripheral data acquired in Step S5 from the memory 12 and generates the 3D model of the read navigation data 41 and peripheral data. The model generation unit 24 writes the generated 3D model into the memory 12.

The 3D model is a plate-like CG content showing the navigation data 41 in the case of the navigation data 41, and is a frame-like CG content surrounding the peripheral of the surface on the moving body 100 side of the object in the case of the peripheral data.

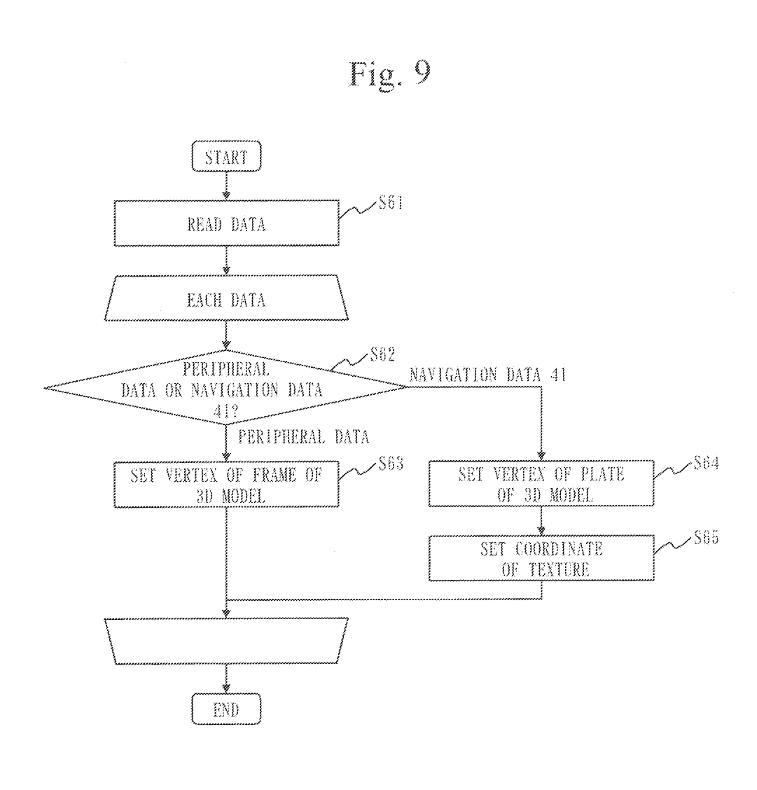

It will be specifically described with reference to FIG. 9.

In Step S61, the model generation unit 24 reads the navigation data 41 acquired in Step S4 and the peripheral data acquired in Step S5 from the memory 12.

The model generation unit 24 performs the processes from Step S62 to Step S65 with the read navigation data 41 and peripheral data as the target data. In Step S62, the model generation unit 24 determines whether the target data is the peripheral data or the navigation data 41.

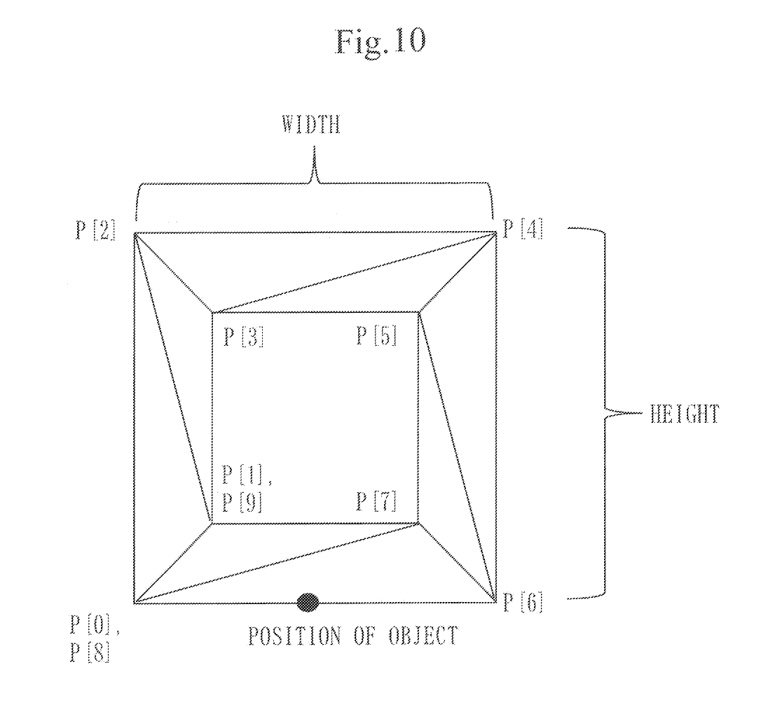

When the target data is the peripheral data, in Step S63, the model generation unit 24 uses the position of the object and the width and height of the object included in the peripheral data, to set vertex strings P [0] to P [9] indicating a set of triangles constituting a frame surrounding the periphery of the surface on the moving body 100 side of the object, as illustrated in FIG. 10. Here, the vertex P [0] and the vertex P [8], the vertex P [1] and the vertex P [9] indicate the same position. A thickness of the frame specified by the distance between the vertex P [0] and the vertex P [1] is arbitrarily set. For all the vertices, the Z value which is a value in the front-rear direction is set to the Z value of the position of the object.

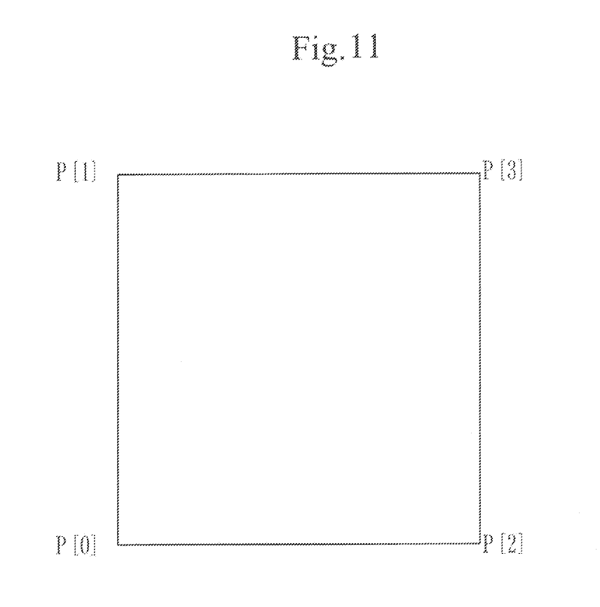

When the target data is the navigation data 41, in Step S64, the model generation unit 24 sets the positions of four end points in the relative coordinate system for the display area of the navigation data 41 to the vertex strings P [0] to P [3], as illustrated in FIG. 11. In Step S65, the model generation unit 24 sets a texture coordinate mapping a texture representing the navigation data 41 to the area surrounded by the vertex strings P [0] to P [3]. As a specific example, (0, 0), (1, 0), (0, 1), (1, 1) indicating mapping of a given texture as a whole are set as the texture coordinates corresponding to an upper left, upper right, lower left, and lower right of the area surrounded by the vertex strings P [0] to P [3].

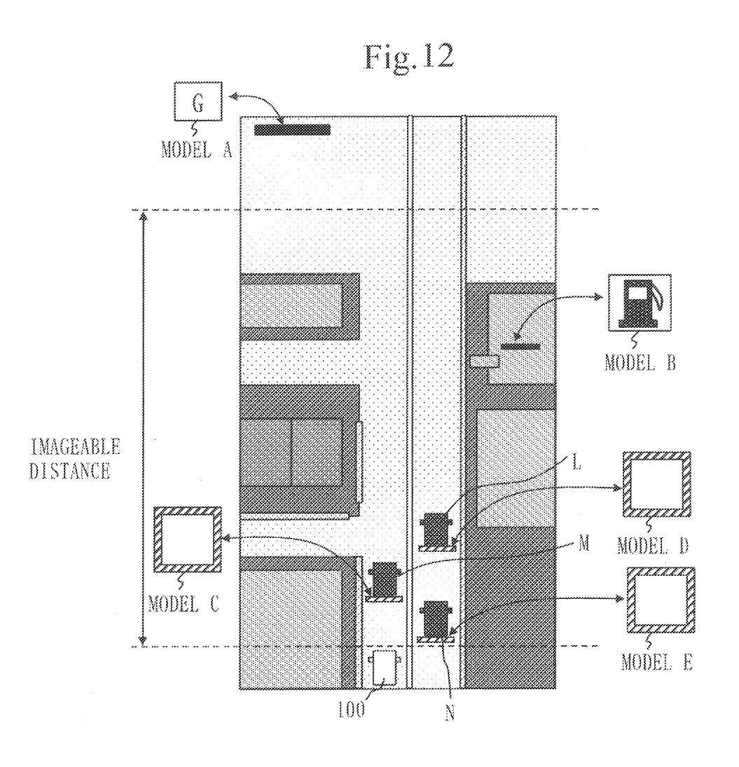

In the case of FIG. 3, as illustrated in FIG. 12, the 3D models of a model A and a model B are generated for the navigation data 41 of the destination and the gas station. In addition, the 3D models of a model C to a model E are generated for the peripheral data of the surrounding vehicles M to L.

(Step S7 in FIG. 2: State Acquisition Process)

The state acquisition unit 25 acquires information on a driving state of the moving body 100 from the ECU 32 via the communication interface 15. In Embodiment 1, the state acquisition unit 25 acquires, as the information on the driving state, a relative distance which is a distance from the moving body 100 to the object corresponding to the peripheral data acquired in Step S5 and a relative speed which is a speed at which the object corresponding to the peripheral data acquired in Step S5 approaches the moving body 100. The relative distance can be calculated from the position of the moving body 100 and the position of the object. The relative speed can be calculated from a change in the relative position between the moving body 100 and the object.

(Step S8 in FIG. 2: Shielding Determination Process)

The shielding determination unit 26 determines whether shielding is allowed for the object according to whether an importance of the object is higher than a threshold value with respect to the object corresponding to the navigation data 41 acquired in Step S4 and the peripheral data acquired in Step S5. When the importance is higher than the threshold value, the shielding determination unit 26 determines that the shielding is not allowed for the object in order to preferentially display the 3D model. When the importance is not higher than the threshold value, the shielding determination unit 26 determines that the shielding is allowed for the object in order to realistically display the 3D model.

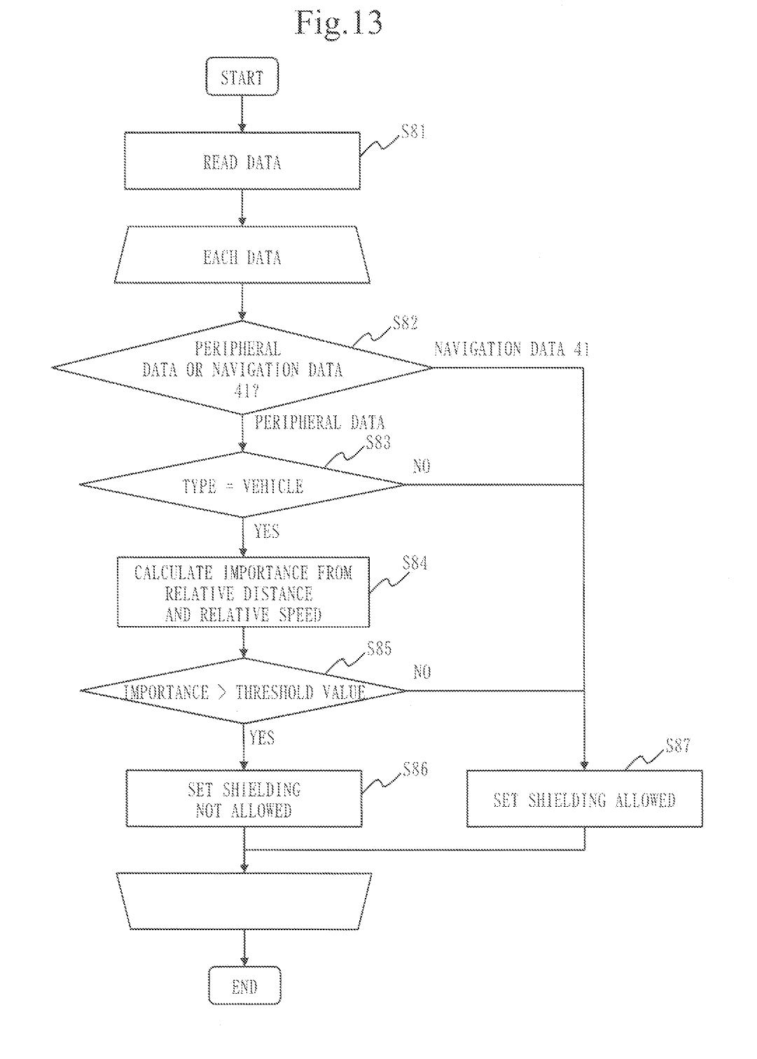

It will be specifically described with reference to FIG. 13.

In Embodiment 1, it is determined whether the shielding is allowed only for the object whose type is a vehicle, and the shielding is allowed for all other types of the object. Note that it may be determined whether the shielding is allowed for other moving bodies such as a pedestrian not limited to the vehicle.

In Step S81, the shielding determination unit 26 reads the navigation data 41 acquired in Step S4 and the peripheral data acquired in Step S5 from the memory 12.

The model generation unit 24 performs the processes from Step S82 to Step S87 with the read navigation data 41 and peripheral data as the target data. In Step S82, the model generation unit 24 determines whether the target data is the navigation data 41 or the peripheral data.

In Step S83, when the target data is the peripheral data, the shielding determination unit 26 determines whether the type of the object corresponding to the target data is the vehicle. When the type of the object is the vehicle, in Step S84, the shielding determination unit 26 calculates the importance from the relative speed and the relative distance acquired in Step S7. Then, in Step S85 to Step S87, the shielding determination unit 26 sets the shielding is not allowed when the importance is higher than the threshold value, and sets the shielding is allowed when the importance is not higher than the threshold value.

On the other hand, when the target data is the navigation data 41 or when the type of the object is not the vehicle, the shielding determination unit 26 sets the shielding is allowed.

In Step S84, the shielding determination unit 26 calculates the importance to be higher as the relative distance is closer, and to be higher as the relative speed is higher. Therefore, the importance is higher as a possibility that the moving body 100 collides with the vehicle which is the object is higher.

As a specific example, the shielding determination unit 26 calculates the importance by Equation 2.

C_{vehicle}=Cₗₑₙ*C_{spd}

Cₗₑₙ=wₗₑₙ exp(−Len²/k_{safelen})

C_{spd}=w_{spd}Spd² [Equation 2]

Here, C_{vehicle} is the importance. Len is the relative distance from the moving body 100 to the object. k_{safelen} is a predefined safety distance factor. wₗₑₙ is a predefined distance cost factor. Spd is the relative speed, takes a positive value in a direction in which the object approaches the moving body 100, and takes a negative value in a direction in which the object moves away from the moving body 100. w_{spd} is a predefined relative speed cost factor.

(Step S9 in FIG. 2: Model Rendering Process)

The display control unit 27 reads the image acquired in Step S1 from the memory 12, renders the 3D model generated in Step S6 to the read image, and generates a display image. Then, the display control unit 27 transmits the generated display image to the display 33 via the display interface 16, and displays it on the display 33.

At this time, the display control unit 27 renders the 3D model, which is the image data indicating the object, to the image regardless of the position of the object, with respect to the object for which it is determined by the shielding determination unit 26 that the shielding is not allowed.

On the other hand, the display control unit 27 determines whether to render the 3D model which is the image data indicating the object according to the position of the object, with respect to the object for which it is determined by the shielding determination unit 26 that the shielding is allowed. That is, with respect to the object for which it is determined that the shielding is allowed, the display control unit 27 does not perform rendering when the object is behind another object and is shielded by the other object, and performs the rendering when the object is in front of the other object and is not shielded by the other object. Note that when only a part of the object is shielded by the other object, the display control unit 27 performs the rendering of only a portion not shielded.

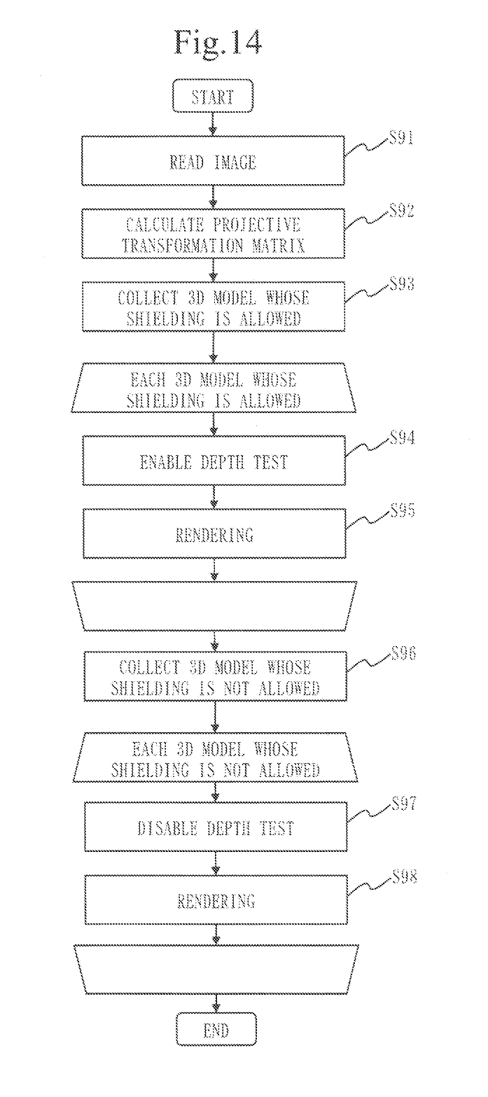

It will be specifically described with reference to FIG. 14.

In Step S91, the display control unit 27 reads the image from the memory 12. Here, the image illustrated in FIG. 4 is read out.

Next, in Step S92, the display control unit 27 calculates a projection matrix which is a transformation matrix for projecting a 3D space onto a two-dimensional image space using the drawing parameter 42. Specifically, the display control unit 27 calculates the projection matrix by Equation 3.

$${Mat}_{proj} = ( \begin{matrix}cot ( {fov}_{w} \text{/} 2 ) \text{/} aspect & 0 & 0 & 0 \\ 0 & cot ( {fov}_{w} \text{/} 2 ) & 0 & 0 \\ 0 & 0 & {Z}_{far} \text{/} ( {Z}_{far} - {Z}_{near} ) & 1 \\ 0 & 0 & - {Z}_{near} {Z}_{far} \text{/} ( {Z}_{far} - {Z}_{near} ) & 0\end{matrix} ) \qquad [ Equation 3 ]$$

Here, Matₚᵣₒⱼ is the projection matrix. aspect is the aspect ratio of the image. Zₙₑₐᵣ is the nearest surface distance. Z_{far} is the farthest surface distance.

Next, in Step S93, the display control unit 27 collects the 3D model generated in Step S6 for the object for which it is determined that the shielding is allowed. Then, the display control unit 27 performs the processes from Step S94 to Step S95 with each collected 3D model as an object model.

In Step S94, the display control unit 27 enables a depth test and performs the depth test. The depth test is a process in which the distance after projective transformation of the object model and the distance in the normalized depth map generated in Step S2 are compared on a pixel basis, and a pixel having a closer distance after the projective transformation of the object model than the distance in the depth map is specified. Note that the depth test is a function supported by GPU or the like, and it can be used by using OpenGL or DirectX which is a graphics library. The object model is subjected to the projective transformation by Equation 4.

$$( \begin{matrix}PicX \\ PicY\end{matrix} ) = ( \begin{matrix}width \text{/} 2 & 0 & width \text{/} 2 \\ 0 & - height \text{/} 2 & height \text{/} 2\end{matrix} ) ( \begin{matrix}ModelX\_norm \\ ModelY\_norm \\ 1\end{matrix} ) \\ ( \begin{matrix}ModelX\_norm \\ ModelY\_norm \\ ModelZ\_norm\end{matrix} ) = ( \begin{matrix}ModelX\_nonnorm \text{/} ModelW\_nonnorm \\ ModelY\_nonnorm \text{/} ModelW\_nonnorm \\ ModelZ\_nonnorm \text{/} ModelW\_nonnorm\end{matrix} ) \\ ( \begin{matrix}NodelX\_nonnorm \\ ModelY\_nonnorm \\ ModelZ\_nonnorm \\ ModelW\_nonnorm\end{matrix} ) = {Mat}_{proj} ( \begin{matrix}ModelX \\ ModelY \\ ModelZ \\ 1\end{matrix} ) \qquad [ Equation 4 ]$$

Here, PicX and PicY are the X value and the Y value of the pixel in a writing destination. width and height are the width and the height of the image. Model X, Model Y and Model Z are the X value, the Y value and the Z value of a vertex coordinate constituting the object model.

In Step S95, the display control unit 27 converts the object model by Equation 4 and then performs the rendering by coloring the pixel specified by the depth test in the image read in Step S91 with a color of the object model.

Next, in Step S96, the display control unit 27 collects the 3D model generated in Step S6 for the object for which it is determined that the shielding is not allowed. Then, the display control unit 27 performs the processes from Step S97 to Step S98 with each collected 3D model as the object model.

In Step S97, the display control unit 27 disables the depth test and does not perform the depth test. In Step S98, the display control unit 27 converts the object model by Equation 4 and then performs rendering by coloring all the pixels indicated by the object model in the image read in Step S91 with the color of the object model.

In FIG. 12, it is assumed that among the destination, the gas station and the surrounding vehicles M to L, which are the objects, it is determined that the shielding is not allowed for the surrounding vehicle L and the shielding is allowed for the remaining objects. That is, it is assumed that the shielding is allowed for the 3D models A, B, C and E, and the shielding is not allowed for the 3D model D.

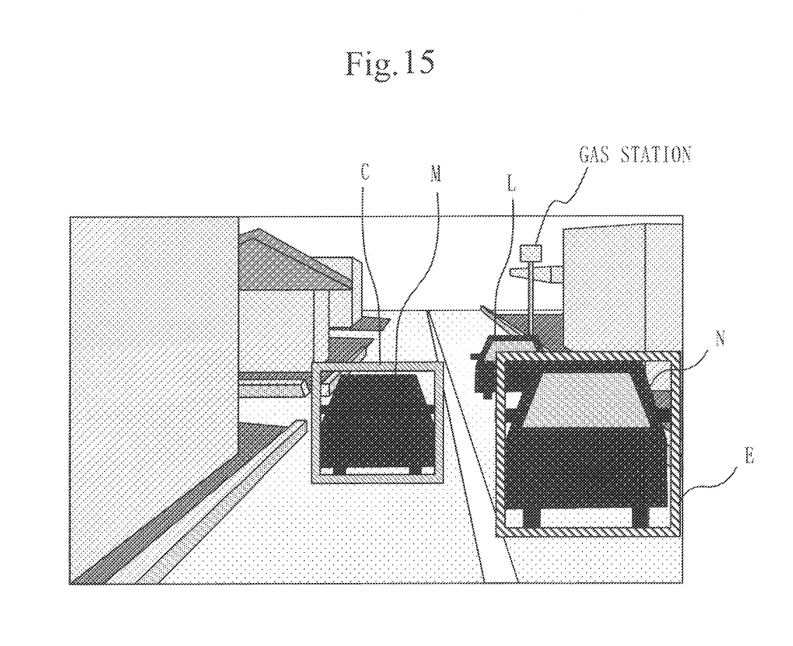

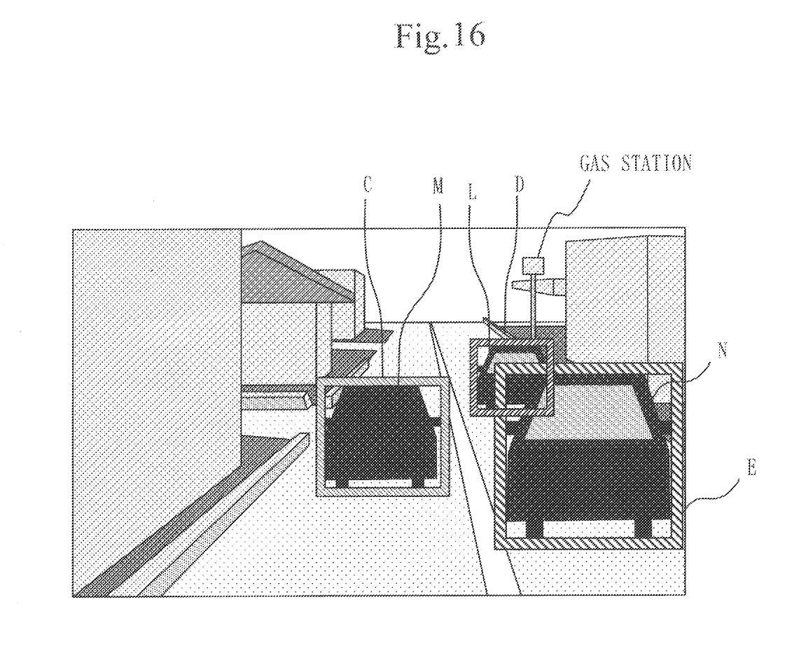

In this case, the 3D models A, B, C and E are rendered as illustrated in FIG. 15 when the process of Step S95 is completed. However, the 3D models A and B are behind the building and shielded by the building, so that they are not rendered. Then, when the process of Step S98 is completed, the 3D model D is rendered as illustrated in FIG. 16. Although the 3D model D is behind the 3D model E, the shielding is not allowed, so that the whole is rendered regardless of the position.

### Effect of Embodiment 1

As described above, the image display device 10 according to Embodiment 1 switches the presence or absence of shielding according to the importance of the object. This makes it easier to see necessary information while maintaining the sense of reality.

That is, since the image display device 10 according to Embodiment 1 displays the object with a high importance by superimposing it on the scenery regardless of the position of the object, it is easy to see the necessary information. On the other hand, it is determined whether to realistically display the object whose importance is not high depending on the position of the object, so that the sense of reality is maintained.

In particular, when the object is a moving object, the image display device 10 according to Embodiment 1 calculates the importance from the relative distance which is the distance from the moving body 100 to the object and the relative speed which is the speed at which the object approaches the moving body 100. Thus, the moving body having a high risk of colliding with the moving body 100 is displayed in a state of being hardly overlooked.

***Other Configurations***

<Modification 1>

In Embodiment 1, the function of each unit of the image display device 10 is realized by software. In Modification 1, the function of each unit of the image display device 10 may be realized by hardware. Modification 1 will be described focusing on differences from Embodiment 1.

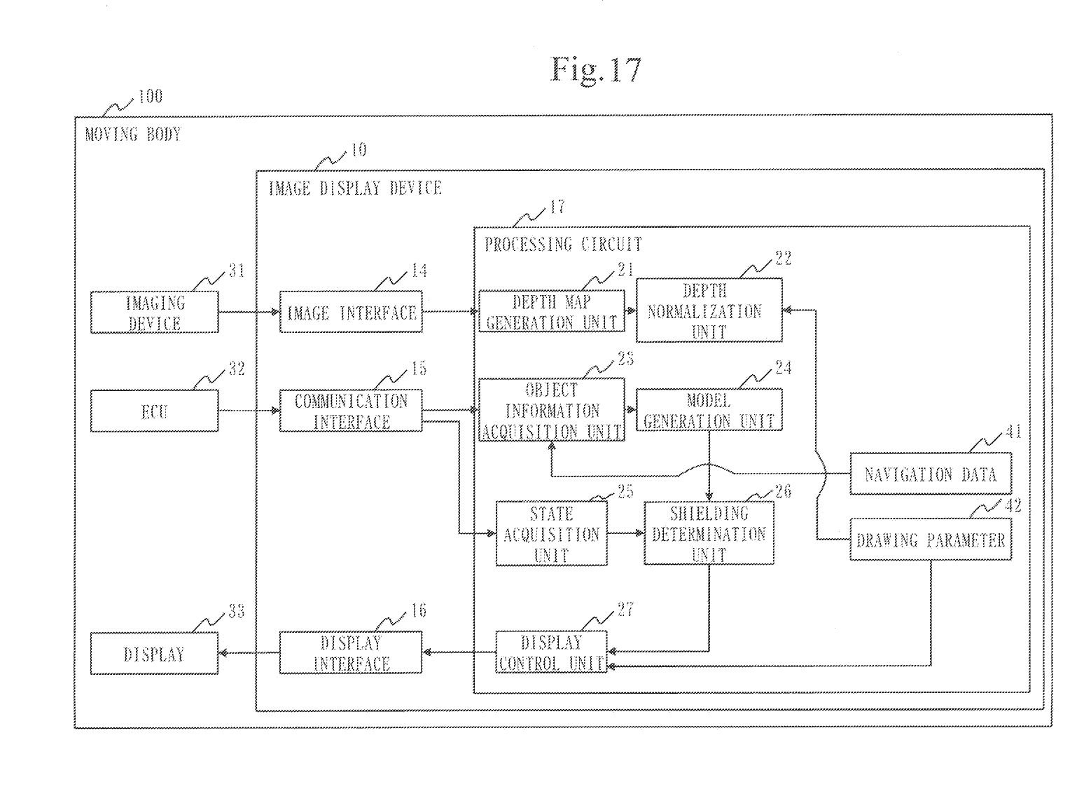

The configuration of the image display device 10 according to Modification 1 will be described with reference to FIG. 17.

When the function of each part is realized by hardware, the image display device 10 includes a processing circuit 17 instead of the processor 11, the memory 12, and the storage 13. The processing circuit 17 is a dedicated electronic circuit which realizes the functions of each unit of the image display device 10 and the functions of the memory 12 and the storage 13.

The processing circuit 17 is assumed to be a single circuit, a composite circuit, a programmed processor, a parallel programmed processor, a logic IC, a gate array (GA), an application specific integrated circuit (ASIC), or a field-programmable gate array (FPGA). The function of each unit may be realized by one processing circuit 17 or the function of each unit may be realized by being distributed to a plurality of processing circuits 17.

<Modification 2>

In Modification 2, some functions may be realized by hardware, and other functions may be realized by software. That is, some of the functions in each unit of the image display device 10 may be realized by hardware, and other functions thereof may be realized by software.

The processor 11, the memory 12, the storage 13, and the processing circuit 17 are collectively referred to as “processing circuitry”. That is, the function of each unit is realized by the processing circuitry.

### Embodiment 2

Embodiment 2 is different from Embodiment 1 in that when a landmark such as the destination is near, the landmark is displayed without shielding. In Embodiment 2, this different point will be described.

In Embodiment 2, as a specific example, a case where it is determined whether the shielding is allowed only for the object whose type is the destination will be described. However, it may be determined whether the shielding is allowed for another landmark designated by a driver or the like not limited to the destination.

***Description of Operation***

The operation of the image display device 10 according to Embodiment 2 will be described with reference to FIGS. 2, 12, 14, and 18 to 20.

The operation of the image display device 10 according to Embodiment 2 corresponds to the image display method according to Embodiment 2. Further, the operation of the image display device 10 according to Embodiment 2 corresponds to the process of the image display program according to Embodiment 2.

The operation of the image display device 10 according to Embodiment 2 is different from the operation of the image display device 10 according to Embodiment 1 in the state acquisition process in Step S7 and the shielding determination process in Step S8 in FIG. 2.

(Step S7 in FIG. 2: State Acquisition Process)

In Embodiment 2, the state acquisition unit 25 acquires the relative distance which is the distance from the moving body 100 to the destination as the information on the driving situation.

(Step S8 in FIG. 2: Shielding Determination Process) As in Embodiment 1, the shielding determination unit 26 determines whether the shielding is allowed for the object according to whether the importance of the object corresponding to the navigation data 41 acquired in Step S4 and the peripheral data acquired in Step S5 is greater than the threshold value. However, the method of calculating the importance is different from that in Embodiment 1.

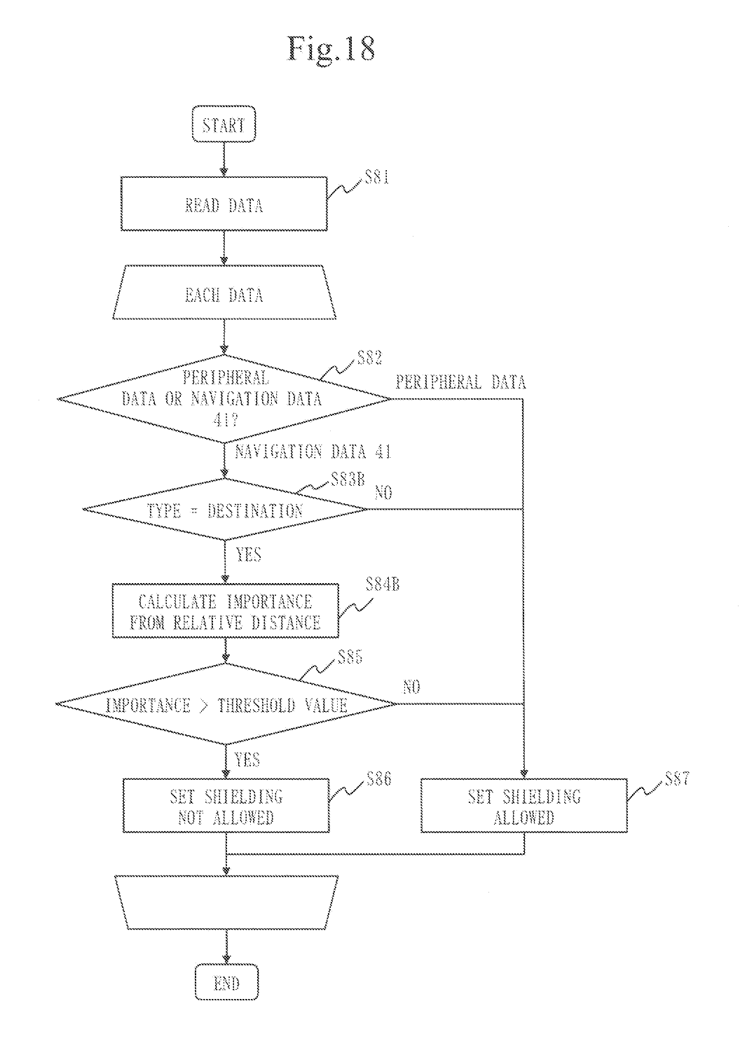

It will be specifically described with reference to FIG. 18.

In Embodiment 2, it is determined whether the shielding is allowed only for the object whose type is the destination, and the shielding is allowed for all other types of the object.

The processes from Step S81 to Step S82 and the processes from Step S85 to Step S87 are the same as those in Embodiment 1.

In Step S83B, when the target data is the navigation data 41, the shielding determination unit 26 determines whether the type of the object corresponding to the target data is the destination. When the type of the object is the destination, in Step S84B, the shielding determination unit 26 calculates the importance from the relative distance acquired in Step S7.

In Step S84B, the shielding determination unit 26 calculates the importance to be higher as the relative distance is farther.

As a specific example, the shielding determination unit 26 calculates the importance by Equation 5.

$${C}_{DestLen} = ( \begin{matrix}{C}_{thres} ⋯ CapMaxLen \leq DestLen \\ 0 ⋯ DestLen < CapMaxLen \end{matrix} \\ DestLen = \vert DestPos - CamPos \vert \qquad [ Equation 5 ]$$

Here, C_{DestLen} is the importance. DestPos is the position of the imaging device 31 in the geographic coordinate system. CamPos is the position of the destination in the geographic coordinate system. CapMaxLen is an imageable distance. Cₜₕᵣₑₛ is a value larger than the threshold value. C_{DestLen} is Cₜₕᵣₑₛ when the distance DestLen between the imaging device 31 and the destination is longer than the imageable distance, and it is 0 when the distance DestLen is shorter than the imageable distance. That is, the importance C_{DestLen} calculated by Equation 5 is a value larger than the threshold value when the distance DestLen between the imaging device 31 and the destination is longer than the imageable distance, and it is a value not larger than the threshold value when the distance DestLen is shorter than the imageable distance.

In FIG. 12, it is assumed that among the destination, the gas station and the surrounding vehicles M to L, which are the objects, it is determined that the shielding is not allowed for the destination and the shielding is allowed for the remaining objects. That is, it is assumed that the shielding is allowed for the 3D models B, C, D and E, and the shielding is not allowed for the 3D model A.

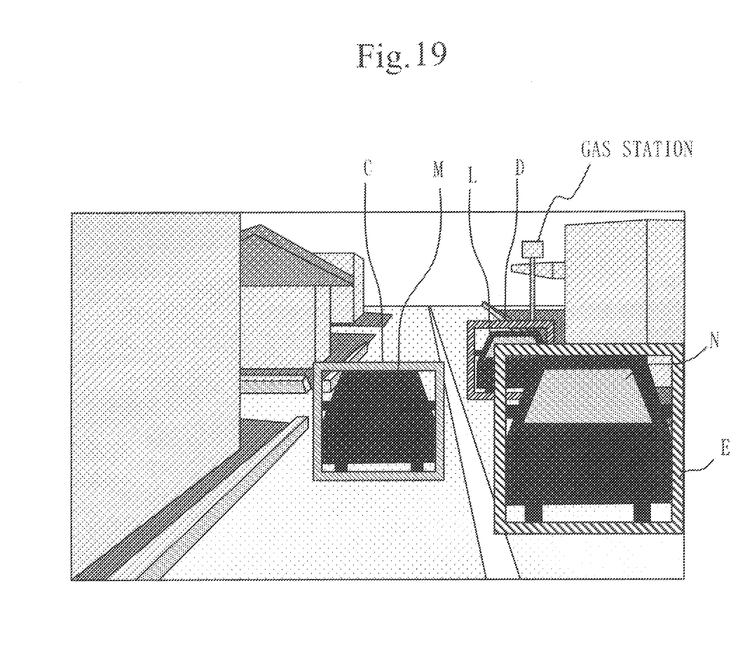

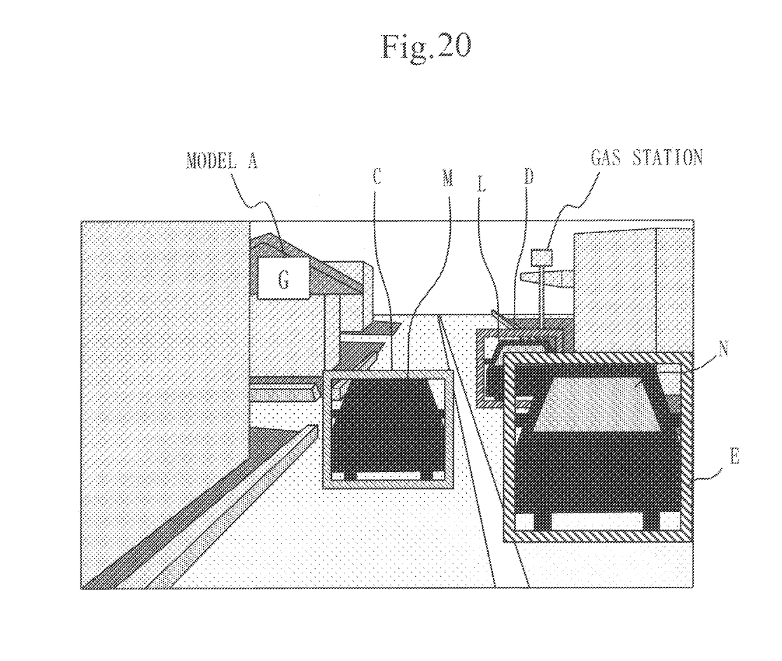

In this case, the 3D models B, C, D and E are rendered as illustrated in FIG. 19 when the process of Step S95 in FIG. 14 is completed. However, the 3D model B is behind the building and shielded by the building, so that it is not rendered. Then, when the process of Step S98 in FIG. 14 is completed, the 3D model A is rendered as illustrated in FIG. 20. Although the 3D model A is behind the building, the shielding is not allowed, so that it is rendered regardless of the position.

### Effect of Embodiment 2

As described above, when the object is the landmark such as the destination, the image display device 10 according to Embodiment 2 calculates the importance from the distance from the moving body 100 to the object. Thus, when the destination is far, the 3D model representing the destination is displayed even when the destination is shielded by the building or the like, so that the direction of the destination can be easily grasped.

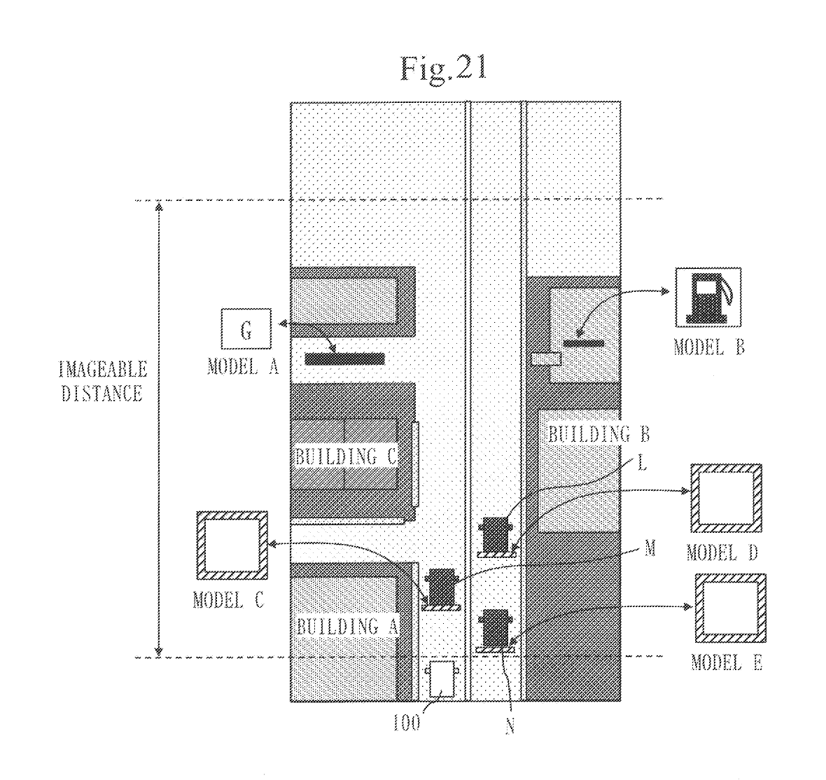

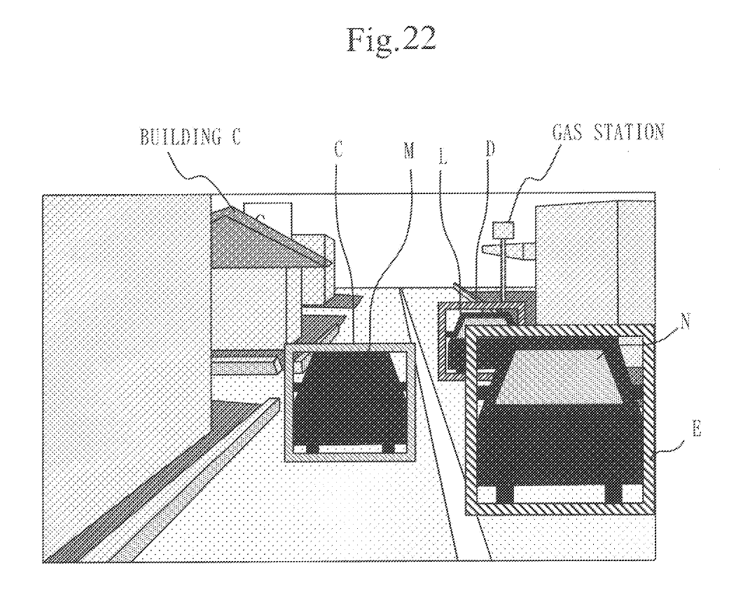

As illustrated in FIG. 21, when the destination is near and is within the imageable distance, it is determined for the 3D model A corresponding to the destination that the shielding is allowed. As a result, as illustrated in FIG. 22, the 3D model A is displayed with a part thereof being shielded by the building C on the front side. Thus, when the destination is near, a positional relationship between the destination and the building or the like is easy to understand.

That is, when the destination is far, the positional relationship with the nearby building or the like is not very important. Therefore, the direction of the destination can be easily understood by displaying the 3D model corresponding to the destination without shielding. On the other hand, when the destination is near, the positional relationship with the nearby building or the like is important. Therefore, the positional relationship with the building or the like is easy to understand by displaying the 3D model corresponding to the destination with shielding.

***Another Configuration***

<Modification 3>

In Embodiment 1, it is determined whether the shielding is allowed for the moving body such as the vehicle, and in Embodiment 2, it is determined whether the shielding is allowed for the landmark such as the destination. As Modification 3, both of the determination of whether the shielding is allowed performed in Embodiment 1 and the determination of whether the shielding is allowed performed in Embodiment 2 may be performed.

### Embodiment 3

Embodiment 3 is different from Embodiments 1 and 2 in that the object in a direction not seen by the driver is displayed without shielding. In Embodiment 3, this different point will be described.

***Description of Configuration***

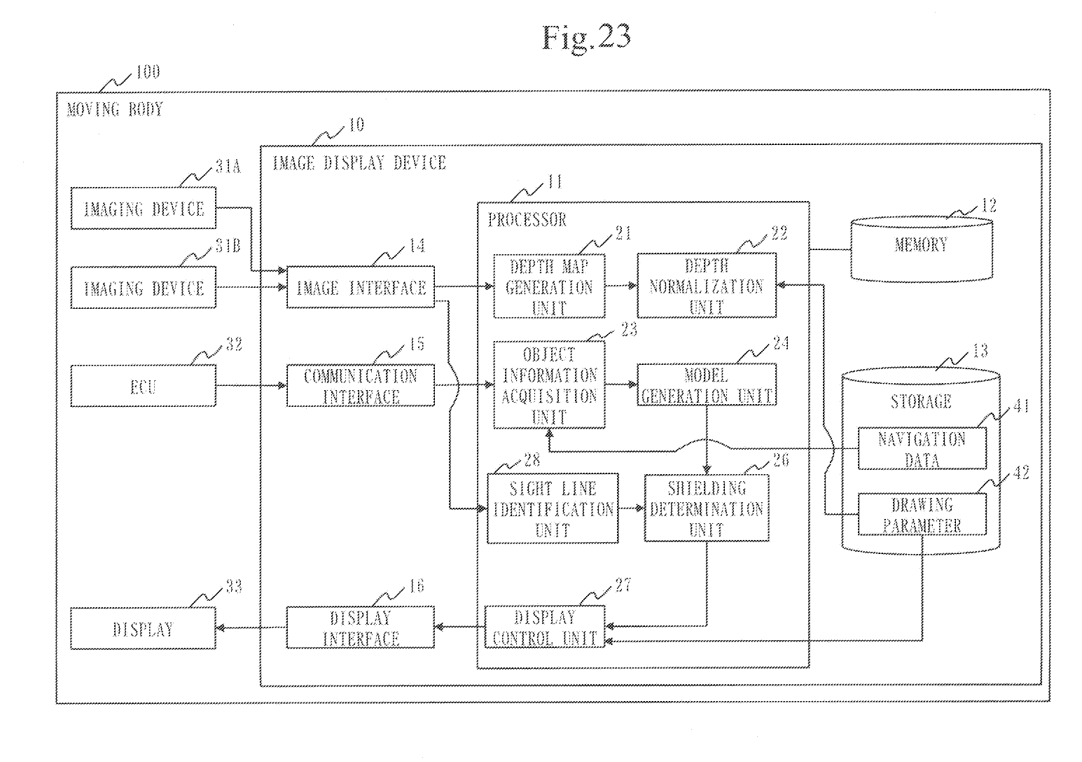

The configuration of the image display device 10 according to Embodiment 3 will be described with reference to FIG. 23.

The image display device 10 according to Embodiment 3 is different from the image display device 10 illustrated in FIG. 1 in that it does not include the state acquisition unit 25 but includes a sight line identification unit 28 as a functional component. The sight line identification unit 28 is realized by software similarly to the other functional components.

In addition, the image display device 10 according to Embodiment 3 includes two imaging devices 31A at the front as in Embodiments 1 and 2, and further includes an imaging device 31B for imaging the driver.

***Description of Operation***

The operation of the image display device 10 according to Embodiment 3 will be described with reference to FIG. 12 and FIGS. 24 to 27.

The operation of the image display device 10 according to Embodiment 3 corresponds to the image display method according to Embodiment 3. Further, the operation of the image display device 10 according to Embodiment 3 corresponds to the process of the image display program according to Embodiment 3.

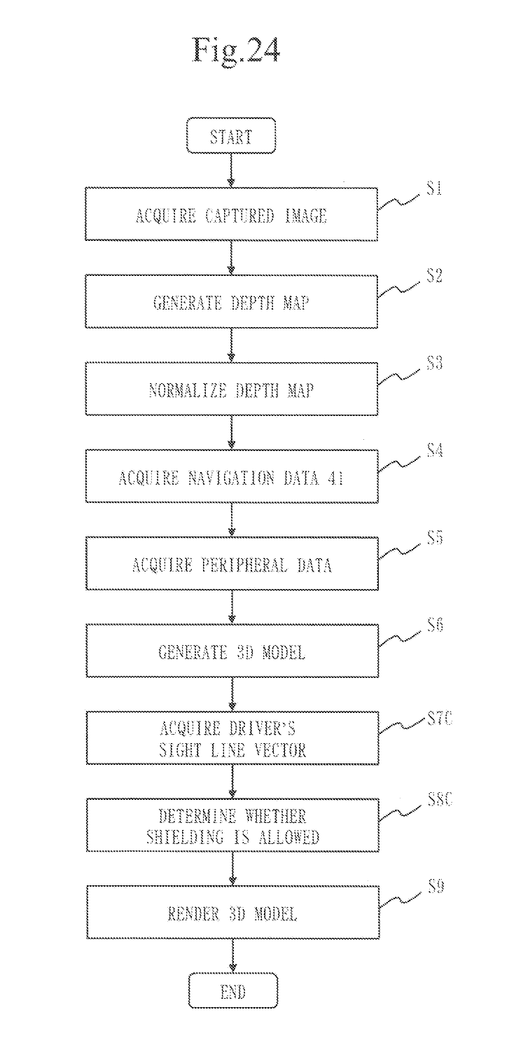

The processes from Step S1 to Step S6 in FIG. 24 is the same as the processes from Step S1 to Step S6 in FIG. 2. Further, the process of Step S9 in FIG. 24 is the same as the process of Step S9 in FIG. 2.

(Step S7C in FIG. 24: Sight Line Identification Process)

The sight line identification unit 28 identifies a sight line vector indicating a direction the driver is looking at. The sight line identification unit 28 writes the identified sight line vector to the memory 12.

As a specific example, the sight line identification unit 28 acquires the image of the driver captured by the imaging device 31B via the image interface 14. Then, the sight line identification unit 28 detects an eyeball from the acquired image and calculates the driver's sight line vector from a positional relationship between a white eye and a pupil.

However, the sight line vector identified here is a vector in a B coordinate system of the imaging device 31B. Therefore, the sight line identification unit 28 converts the specified sight line vector into the sight line vector in an A coordinate system of the imaging device 31A which images the front of the moving body 100. Specifically, the sight line identification unit 28 converts the coordinate system of the sight line vector using the rotation matrix calculated from a relative orientation between the imaging device 31A and the imaging device 31B. It should be noted that the relative orientation is identified from the installation positions of the imaging devices 31A and 31B in the moving body 100.

When a moving body coordinate system is defined as a coordinate system in which a lateral direction of the moving body 100 is an X coordinate, the upward direction is a Y coordinate, and a traveling direction is a Z coordinate, and rotation angles of the X-axis, the Y-axis, and the Z-axis in the moving body coordinate system corresponding to the lateral direction, the upward direction, the optical axis direction of the imaging device 31A are respectively defined as Pitch_{cam}, Yaw_{cam}, and Roll_{cam}, transformation matrix Mat_{car2cam} from the moving body coordinate system to the A coordinate system is as shown in Equation 6.

$${Mat}_{car 2 cam} = ( \begin{matrix}cos {Roll}_{cam} & - sin {Roll}_{cam} & 0 \\ sin {Roll}_{cam} & cos {Roll}_{cam} & 0 \\ 0 & 0 & 1\end{matrix} ) ( \begin{matrix}cos {Yaw}_{cam} & 0 & sin {Yaw}_{cam} \\ 0 & 1 & 0 \\ - sin {Pitch}_{cam} & 0 & cos {Yaw}_{cam}\end{matrix} ) ( \begin{matrix}1 & 0 & 0 \\ 0 & cos {Pitch}_{cam} & - sin {Pitch}_{cam} \\ 0 & sin {Pitch}_{cam} & cos {Pitch}_{cam}\end{matrix} ) \qquad [ Equation 6 ]$$

When rotation angles of the X-axis, the Y-axis, and the Z-axis of the moving body coordinate system corresponding to the lateral direction, the upward direction, and the optical axis direction of the imaging device 31B are respectively defined as Pitch_{drc}, Yaw_{drc}, and Roll_{drc}, transformation matrix Mat_{car2drc} from the moving body coordinate system to the B coordinate system is as shown in Equation 7.

$${Mat}_{car 2 drc} = ( \begin{matrix}cos {Roll}_{drc} & - sin {Roll}_{drc} & 0 \\ sin {Roll}_{drc} & cos {Roll}_{drc} & 0 \\ 0 & 0 & 1\end{matrix} ) ( \begin{matrix}cos {Yaw}_{drc} & 0 & sin {Yaw}_{drc} \\ 0 & 1 & 0 \\ - sin {Pitch}_{drc} & 0 & cos {Yaw}_{drc}\end{matrix} ) ( \begin{matrix}1 & 0 & 0 \\ 0 & cos {Pitch}_{drc} & - sin {Pitch}_{drc} \\ 0 & sin {Pitch}_{drc} & cos {Pitch}_{drc}\end{matrix} ) \qquad [ Equation 7 ]$$

Then, since the conversion from the B coordinate system to the A coordinate system is Mat_{car2cam}·(Mat_{car2drc})^{t}, the sight line vector in the A coordinate system is calculated by Equation 8.

V_{cam}=Mat_{car2cam}Mat_{car2drc}^{t}V_{drc} [Equation 8]

Here, V_{cam} is the sight line vector in the A coordinate system, and V_{drc} is the sight line vector in the B coordinate system.

Since hardware for a sight line detection is also commercially available, the sight line identification unit 28 may be realized by such hardware.

(Step S8C in FIG. 24: Shielding Determination Process)

As in Embodiment 1, the shielding determination unit 26 determines whether the shielding is allowed for the object according to whether the importance of the object corresponding to the navigation data 41 acquired in Step S4 and the peripheral data acquired in Step S5 is greater than the threshold value. However, the method of calculating the importance is different from that in Embodiment 1.

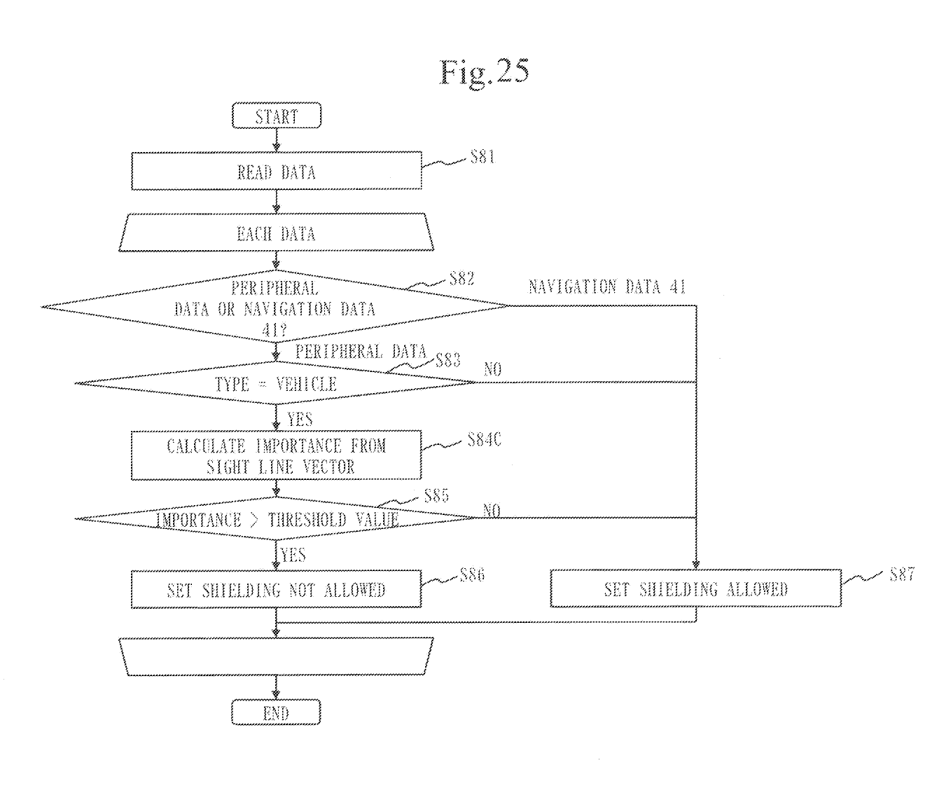

It will be specifically described with reference to FIG. 25.

In Embodiment 3, it is determined whether the shielding is allowed only for the object whose type is a vehicle, and the shielding is allowed for all other types of the object. Note that it may be determined whether the shielding is allowed for other moving bodies such as the pedestrian and the landmark such as the gas station not limited to the vehicle.

The processes from Step S81 to Step S83 and the processes from Step S85 to Step S87 are the same as those in Embodiment 1.

In Step S84C, the shielding determination unit 26 calculates the importance to be higher as a deviation between the position of the object and the position seen by the driver indicated by the sight line vector is larger.

As a specific example, the shielding determination unit 26 calculates the importance by Equation 9.

$${C}_{watch} = {w}_{watch} \frac{\vert θ \vert}{π} \\ θ = {cos}^{- 1} \frac{{V}_{cam} \cdot {P}_{obj}}{\vert {V}_{cam} \vert \vert {P}_{obj} \vert} ⋯ - π < θ \leq π \qquad [ Equation 9 ]$$

Here, C_{watch} is the importance. P_{obj} is the position of the object. θ is an angle formed by the sight line vector and a target vector from the imaging device 31A to the object. w_{watch} is a viewing cost coefficient, which is an arbitrarily determined positive constant.

It is assumed that the driver sees the middle between the surrounding vehicle M and the surrounding vehicle L in FIG. 12. Then, the deviation between the position of the surrounding vehicle N and the position seen by the driver indicated by the sight line vector increases, and the importance of the surrounding vehicle N is high. Therefore, it is assumed that among the destination, the gas station and the surrounding vehicles M to L, which are the objects, it is determined that the shielding is not allowed for the surrounding vehicle N and the shielding is allowed for the remaining objects. That is, it is assumed that the shielding is allowed for the 3D models A to D and the shielding is not allowed for the 3D model E.

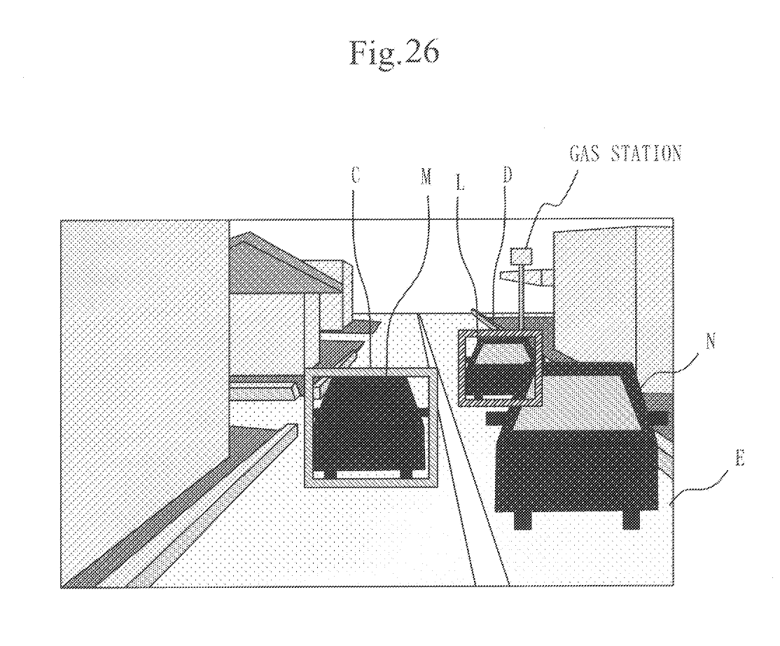

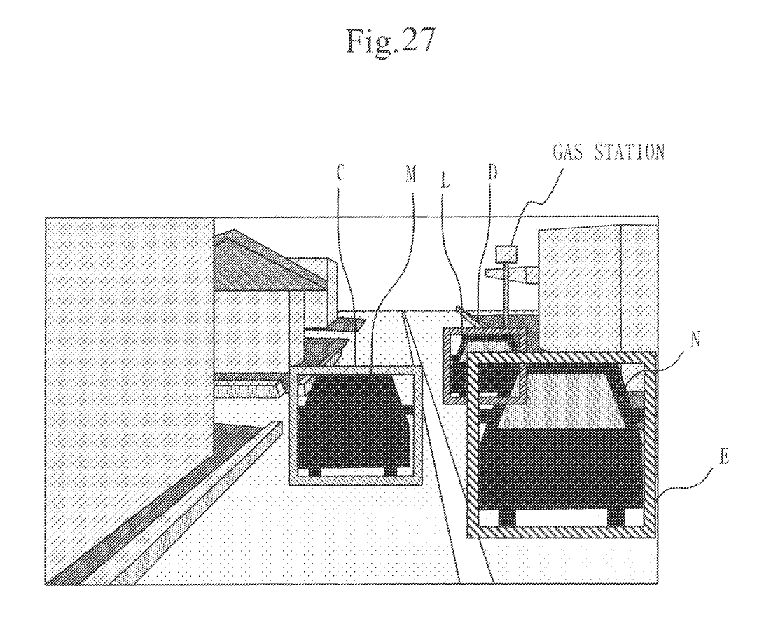

In this case, as illustrated in FIG. 26, the 3D models A to D are rendered when the process of Step S95 is completed. However, since the 3D models A and B are behind the building and shielded by the building, they are not rendered. When the process of Step S98 is completed, the 3D model E is rendered as illustrated in FIG. 27.

### Effect of Embodiment 3

As described above, the image display device 10 according to Embodiment 3 calculates the importance from the deviation from the position seen by the driver. Thus, when there is a high possibility that the driver overlooks the object, the 3D model corresponding to the object is displayed without shielding, so that the driver can be notified of the object.

On the other hand, the shielding is allowed for the object highly likely to be noticed by the driver, and the positional relationship is easy to understand.

***Another Configuration***

<Modification 4>

In Embodiment 1, it is determined whether the shielding is allowed for the moving body such as the vehicle based on the relative position and the relative speed, and in Embodiment 2, it is determined whether the shielding is allowed for the landmark such as the destination based on the relative position. In Embodiment 3, it is determined whether the shielding is allowed based on the deviation from the position the driver is looking at. As Modification 4, both of the determination of whether the shielding is allowed performed in at least one of Embodiments 1 and 2, and the determination of whether the shielding is allowed performed in Embodiment 3 may be performed.

### REFERENCE SIGNS LIST

10: image display device, 11: processor, 12: memory, 13: storage, 14: image interface, 15: communication interface, 16: display interface, 17: processing circuit, 21: depth map generation unit, 22: depth normalization unit, 23: object information acquisition unit, 24: model generation unit, 25: state acquisition unit, 26: shielding determination unit, 27: display control unit, 28: sight line identification unit, 31, 31A, 31B: imaging device, 32: ECU, 33: display, 41: navigation data, 42: drawing parameter, 100: moving body.

1.-9. (canceled)

10. An image display device comprising:
processing circuitry to:
acquire information of an object around a moving body;
determine that shielding is not allowed for the object when an acquired importance of the object is higher than a threshold value; and
display image data indicating the object by superimposing it on a scenery around the moving body regardless of a position of the object, with respect to the object for which it is determined that the shielding is not allowed, wherein
when the object is a moving object, the importance is calculated from a relative distance which is a distance from the moving body to the object and a relative speed which is a speed at which the object approaches the moving body.

11. The image display device according to claim 10, wherein
the importance is higher as the relative distance is closer and is higher as the relative speed is faster.

12. The image display device according to claim 10, wherein
when the object is a landmark, the importance is higher as a relative distance which is a distance from the moving body to the object is farther.

13. The image display device according to claim 10, wherein
the importance is higher as a deviation between the position of the object and a position where a driver of the moving body sees is larger.

14. The image display device according to claim 10, wherein
the information of the object is navigation data for guiding the object stored in a storage and sensor data obtained from a sensor value detected by a sensor.

15. The image display device according to claim 10, wherein
the processing circuitry controls whether to display the object by superimposing it on the scenery in accordance with the position of the object, with respect to the object for which it is determined that the shielding is allowed.

16. An image display method comprising:
acquiring information of an object around a moving body, by a processor;
determining that shielding is not allowed for the object when an acquired importance of the object is higher than a threshold value; and
displaying image data indicating the object by superimposing it on a scenery around the moving body regardless of a position of the object, with respect to the object for which it is determined that the shielding is not allowed, wherein
when the object is a moving object, the importance is calculated from a relative distance which is a distance from the moving body to the object and a relative speed which is a speed at which the object approaches the moving body.

17. A non-transitory computer readable medium storing an image display program to cause a computer to execute:
an object information acquisition process of acquiring information of an object around a moving body;
a shielding determination process of determining that shielding is not allowed for the object when an importance of the object acquired by the object information acquisition process is higher than a threshold value; and
a display control process of displaying image data indicating the object by superimposing it on a scenery around the moving body regardless of a position of the object, with respect to the object for which it is determined by the shielding determination process that the shielding is not allowed, wherein
when the object is a moving object, the importance is calculated from a relative distance which is a distance from the moving body to the object and a relative speed which is a speed at which the object approaches the moving body.
